(19) United States
(12) Patent Application Publication
(10) Pub. No.: US 2022/0062992 A1
(43) Pub. Date: Mar. 3, 2022

(54) NICKEL-BASED SUPERALLOY FOR 3D PRINTING AND POWDER PREPARATION METHOD THEREOF

(71) Applicant: CENTRAL SOUTH UNIVERSITY, Changsha (CN)

(72) Inventors: Zuming LIU, Changsha (CN); Bing WEI, Changsha (CN); Bizhong NONG, Changsha (CN); Xueqian LV, Changsha (CN); Yake REN, Changsha (CN); Bin CAO, Changsha (CN); Yongkang AI, Changsha (CN)

(73) Assignee: CENTRAL SOUTH UNIVERSITY, Changsha (CN)

(21) Appl. No.: 17/496,809

(22) Filed: Oct. 8, 2021

Related U.S. Application Data
(63) Continuation of application No. PCT/CN2021/105818, filed on Jul. 12, 2021.

(30) Foreign Application Priority Data
Aug. 30, 2020 (CN) 202010891092.2

(51) Int. Cl. B22F 9/08; B33Y 40/10; B33Y 70/00; C22C 30/00

(52) U.S. Cl. CPC B22F 9/082; B33Y 40/10; B22F 2009/0896; C22C 30/00; B22F 2009/0848; B33Y 70/00

(57) ABSTRACT

A nickel-based superalloy for three-dimension (3D) printing and a powder preparation method thereof are provided. The method of preparing the nickel-based superalloy and its powder includes: RE microalloying combined with vacuum melting, degassing, refining, atomization with reasonable parameters, and a sieving process. The new method significantly reduces the cracking sensitivity of the “non-weldable” PM nickel-based superalloys, and broadens the 3D printing process window. The as-printed part has no cracks, and good mechanical properties. In addition, the powder prepared by the new method has higher sphericity and better flowability, and less irregular powders. The yield of fine powders with a particle size of 15-53 μm and medium-sized powders with a particle size of 53-106 μm that are required for 3D printing is greatly improved, which meet the requirements for 3D printing of high-quality, low-cost nickel-based superalloy powder.

### CROSS REFERENCE TO THE RELATED APPLICATIONS

This application is the continuation application of International Application No. PCT/CN2021/105818, filed on Jul. 12, 2021, which is based upon and claims priority to Chinese Patent Applications No. 202010891092.2, filed on Aug. 30, 2020, the entire contents of which are incorporated herein by reference.

### TECHNICAL FIELD

The present disclosure provides a nickel-based superalloy for three-dimension (3D) printing and a powder preparation method thereof, and belongs to the technical field of superalloy and additive manufacturing (AM).

### BACKGROUND

With the rapid development of metal 3D printing technologies, the demand for high-quality and low-cost metal powder is increasing. The development of 3D printing technologies for aerospace high-performance nickel-based superalloy is limited by the “weldability” of the nickel-based superalloy and the quality of its powder. At present, the nickel-based superalloys used for 3D printing mainly include IN718, IN625, which have good 3D printing formability, but are worse than powder metallurgy (PM) nickel-based superalloys in overall performance. Due to the high content of Al and Ti, PM nickel-based superalloys are highly sensitive to cracking. They are prone to cracking during 3D printing, which brings a huge challenge to the 3D printing of PM nickel-based superalloys. It is an urgent problem to be solved in the field of 3D printing of nickel-based superalloy to develop a PM nickel-based superalloy suitable for 3D printing and a technology for preparing its powder.

Due to the high content of Al and Ti, conventional PM nickel-based superalloys are highly sensitive to cracking, and are not suitable for 3D printing. Currently, there has been no relevant report on PM nickel-based superalloys suitable for 3D printing.

The as-built defects are closely related to the flowability and impurity content of the powder. Therefore, 3D printing technology imposes higher requirements on the powder performance, especially nickel-based superalloys. The flowability of the powder directly affects the uniformity of powder spreading during selective laser melting (SLM) and electron beam melting (EBM) and the stability of powder feeding during laser engineered net shaping (LENS), which has an impact on the quality of 3D printed parts. The flowability of the powder is affected by factors such as the particle size and size distribution of the powder, the shape of the powder, and moisture absorbed by the powder. In order to ensure the flowability of the powder, the powder is required to be spherical or nearly spherical, with a particle size between a dozen microns and one hundred microns. As for the powder used for 3D printing of nickel-based superalloy, there are also problems such as poor composition uniformity, high oxygen content, poor sphericity, and low yield of powders with a particle size distribution suitable for 3D printing.

In view of the above problems, exploratory research has been carried out. Chinese Patent No. CN107716934A discloses a method for preparing Inconel 718 superalloy powders for 3D printing. In this patent, vacuum induction melting and close-coupled gas atomization are adopted, and ultrasonic vibration and airflow classification methods are used to formulate the powder particle sizes, to prepare Inconel 718 alloy powders suitable for SLM technology. Chinese Patent No. CN105624472A discloses a nickel-based superalloy powder for 3D printing and a preparation method thereof. The alloy powder includes the following chemical components in percentage by weight: Ni 50-80%, Al 3-7%, Si ≤1%, Ti 1-6%, V 0.1-1%, Cr 2-10%, Mn ≤1%, Fe 1.68%, and Co 8-15%. The preparation steps are: weighing raw materials based on the weight ratio, and melting the raw materials in a vacuum melting furnace; then, atomizing the melt with high-pressure argon at a superheat of 20-40° C. to obtain alloy powder; and finally, performing high-temperature annealing treatment on the alloy powder under an argon atmosphere, and then performing vibration sieving, followed by graded vacuum packaging after cooling, to obtain the nickel-based superalloy powder. Chinese Patent No. CN107326218A discloses a method for preparing a DD5 superalloy powder for 3D printing. In this patent, a component homogenization heat treatment is performed on the DD5 master alloy ingot, and the DD5 alloy powder is prepared by plasma rotating electrode process (PREP) under an inert gas atmosphere. The patents above mainly adopt powdering processes, and improve the flowability and sphericity of the powder and reduce the oxygen content of the powder to satisfy the requirements on powders for 3D printing. Chinese Patent No. CN108941560B discloses a method for eliminating cracks in René 104 nickel-based superalloy prepared by laser additive manufacturing. This patent proposes a solution of eliminating the cracks in the fabricated part and inhibiting the grain growth during the sintering process by designing laser process parameters and partition scanning strategies combined with stress relief annealing and spark plasma sintering (SPS). However, “non-weldable” nickel-based superalloys are prone to cracking and are difficult to build during 3D printing, and the prepared powders cannot satisfy the requirements for 3D printing of high-performance nickel-based superalloy parts. In addition, there have been no related reports about reducing the formation of cracks at a greatest probability by adopting microalloying combined with the powdering process during 3D printing.

In the present disclosure, by introducing an appropriate amount of rare earth (RE) for microalloying, the cracking sensitivity of the “non-weldable” nickel-based superalloy during 3D printing is significantly reduced, and a high-performance nickel-based superalloy suitable for 3D printing is obtained. Through a combination of vacuum melting, degassing, refining, atomization, and the sieving process, a nickel-based superalloy powder satisfying the requirements for 3D printing is prepared. The present disclosure significantly reduces the oxygen and sulfur contents of the nickel-based superalloy powder, and improves the sphericity and flowability of the powder and the yield of fine powders with a particle size of 15-53 μm and medium-sized powders with a particle size of 53-106 μm, which satisfies the requirements for 3D printing of high-performance nickel-based superalloy powders.

### SUMMARY

To solve the problem that “non-weldable” nickel-based superalloys are prone to cracking during 3D printing, the present disclosure provides a nickel-based superalloy for 3D printing and a powder preparation method thereof. The objective is to significantly reduce the cracking sensitivity of the “non-weldable” nickel-based superalloy during 3D printing and to obtain a high-performance nickel-based superalloy suitable for 3D printing. The prepared powder has good sphericity, low oxygen and sulfur content, narrow particle size distribution, high apparent density, and good flowability. There are few irregular powders, and the powder yield with particle sizes of 15-53 μm and 53-106 μm is greatly improved. In addition, the cracking sensitivity of the “non-weldable” nickel-based superalloy during 3D printing is significantly reduced, which meets the requirements for 3D printing of high-performance nickel-based superalloy powder. The present disclosure significantly broadens the 3D printing process window of nickel-based superalloy, reduces the risk of a sharp drop in product performance caused by uncontrollable factors during 3D printing, and can print parts with no cracks and excellent mechanical properties. The performance of the as-printed parts will be further improved by subsequent heat treatment.

The present disclosure provides a nickel-based superalloy for 3D printing, which comprises the following components in percentage by mass:
Co: 14-23 wt %;
Cr: 11-15 wt %;
Al: 2-5 wt %;
Ti: 3-6 wt %;
Mo: 2.7-5 wt %;
W: 0.5-3 wt %;
Ta: 0.5-4 wt %;
Nb: 0.25-3 wt %;
Zr: 0.02-0.06 wt %;
B: 0.01-0.05 wt %;
C: 0.0015-0.1 wt %;
RE: 0.05-0.18 wt %; and
Ni: the balance,

or another non-weldable nickel-based superalloy is used as a matrix, and 0.05-0.18 wt % of RE is added to the matrix, where:

the another non-weldable nickel-based superalloy is one selected from the group consisting of IN738LC, CM247LC, CMSX-4, René 142, and Hastelloy X; or one selected from the group consisting of IN718 and IN625 nickel-based superalloys is used as the matrix, and 0.05-0.18 wt % of RE is added to the matrix.

In the nickel-based superalloy for 3D printing provided in the present disclosure, the nickel-based superalloy for 3D printing comprises the following components in percentage by mass:
Co: 20.6 wt %;
Cr: 13 wt %;
Al: 3.4 wt %;
Ti: 3.9 wt %;
Mo: 3.8 wt %;
W: 2.1 wt %;
Ta: 2.4 wt %;
Nb: 0.9 wt %;
Zr: 0.05 wt %;
B: 0.03 wt %;
C: 0.04 wt %;
RE: 0.06-0.18 wt %, and further preferably, 0.07-0.09 wt %; and
Ni: the balance.

In the nickel-based superalloy for 3D printing provided in the present disclosure, wherein RE is at least one selected from the group of Sc, Y, La, Ce, and Er.

In the nickel-based superalloy for 3D printing provided in the present disclosure, wherein RE is Sc, or RE is a mixture of Sc and at least one selected from the group of Y, La, Ce, and Er. During research and development, it is found that given a certain amount of RE added, the product has a highest yield and best quality when the RE element is only Sc.

The present disclosure provides a method for preparing nickel-based superalloy powder for 3D printing, including the following steps:

### Step 1: Vacuum Melting

formulating raw materials according to designed components, putting the raw materials into a melting crucible of a powder atomization furnace, and then vacuum melting by induction heating under a vacuum degree of higher than 0.1 Pa;

### Step 2: Degassing

after the raw materials are melted and completely alloyed to obtain a molten master alloy melt, vacuum degassing the molten master alloy melt for 10 min-20 min;

### Step 3: Refining

introducing high-purity inert gas into the powder atomization furnace to 0.1-0.11 MPa, and holding the molten master alloy melt at a temperature of 1600° C.-1650° C. for 10 min-15 min;

### Step 4: Atomization

flowing the molten master alloy melt down a draft tube at a flow rate of 3.5 kg/min-5 kg/min, atomizing the molten master alloy melt into fine droplets with 3 MPa-5 MPa high-pressure and the high-purity inert gas, cooling and solidifying the fine droplets to form spherical powders, and collecting the spherical powders using a tank; and

### Step 5: Sieving

sieving the spherical powders by airflow classification and ultrasonic vibration with sieve mesh numbers of 100 and 270 under an inert gas atmosphere after the spherical powders are fully cooled, to obtain spherical nickel-based superalloy powders with a particle size of 53-106 μm and a particle size of 15-53 μm, and then vacuum packaging;

wherein the high-purity inert gas is helium, argon, or a mixture gas of argon and helium, with a purity of 99.99 wt %, and an oxygen content less than 0.0001 wt %.

In the method for preparing nickel-based superalloy powder for 3D printing provided in the present disclosure, the raw materials contain Al-RE intermediate alloy.

In the method for preparing nickel-based superalloy powder for 3D printing provided in the present disclosure, a total yield of the medium-sized powders with a particle size of 53-106 μm and the fine powders with a particle size of 15-53 μm is 88.5%-91.5%.

In the method for preparing nickel-based superalloy powder for 3D printing provided in the present disclosure, the obtained nickel-based superalloy powder for 3D printing has an oxygen content less than or equal to 0.0126 wt %, and a sulfur content less than or equal to 0.0056 wt %. In industrial applications, the PREP can also be used to prepare the nickel-based superalloy powders.

After optimization, in the method for preparing nickel-based superalloy powder for 3D printing provided in the present disclosure, the obtained nickel-based superalloy powder for 3D printing has an oxygen content less than or equal to 0.01 wt %, and a sulfur content less than or equal to 0.004 wt %.

In the method for preparing nickel-based superalloy powder for 3D printing provided in the present disclosure, the obtained nickel-based superalloy powder for 3D printing has a flowability of 15-25 s/50 g, preferably 15.5-16 s/50 g, through an aperture of 2.5 mm.

### Advantages and Positive Effects of the Present Disclosure

(1) The present disclosure provides a nickel-based superalloy for 3D printing and a powder preparation method thereof, where by introducing an appropriate amount of RE for microalloying, the cracking sensitivity of René 104 nickel-based superalloy during 3D printing is significantly reduced. The PM nickel-based superalloy powder prepared by the present disclosure has a uniform composition and can be directly used for 3D printing. In addition, the possibility of crack formation in the as-printed part during 3D printing is far lower than that of conventional nickel-based superalloy.

(2) The present disclosure provides a nickel-based superalloy for 3D printing and a powder preparation method thereof, where by introducing an appropriate amount of RE for microalloying, the 3D printing process window of nickel-based superalloy is broadened, and the problem that the nickel-based superalloy is prone to cracking and difficult to build during 3D printing is resolved.

(3) The present disclosure provides a nickel-based superalloy for 3D printing and a powder preparation method thereof, where the prepared alloy and its powder can improve the mechanical properties of the 3D printed part and inhibit the formation and propagation of crack.

(4) The present disclosure provides a nickel-based superalloy for 3D printing and a powder preparation method thereof, where by adding minor RE elements to René 104 nickel-based superalloy, the oxygen and sulfur contents of the powder are effectively reduced, thereby eliminating the phenomenon of poor fusion and even cracking during 3D printing.

(5) The present disclosure provides a nickel-based superalloy for 3D printing and a powder preparation method thereof, where by adding an appropriate amount of RE elements to René 104 nickel-based superalloy (especially introducing 0.07-0.09 wt % of RE into René 104 nickel-based superalloy) and adopting a suitable atomization process, the obtained nickel-based superalloy powder has good sphericity, low oxygen and sulfur content, narrow particle size distribution, high apparent density, and good flowability. Irregular powders are significantly reduced, and the powder yield with particle sizes of 15-53 μm and 53-106 μm is greatly improved (up to 91.5%). In this way, the performance of the nickel-based superalloy powder for 3D printing is greatly improved, to meet the requirements for 3D printing of nickel-based superalloys.

### BRIEF DESCRIPTION OF THE DRAWINGS

FIG. 1 presents a scanning electron microscope (SEM) image showing the morphology of the René 104 alloy powder with minor RE elements in Example 1;

FIG. 2 presents a high-magnification SEM image showing the morphology of the René 104 alloy powder with minor RE elements in Example 1;

FIG. 3 presents a particle size distribution curve of the René 104 alloy powder with minor RE elements in Example 1;

FIG. 4 presents an SEM image showing the microstructure of the René 104 alloy part prepared in Example 4;

FIG. 5 presents an SEM image showing the morphology of the René 104 alloy powder without minor RE elements in Comparative Example 1;

FIG. 6 presents a high-magnification SEM image showing the morphology of the René 104 alloy powder without minor RE elements in Comparative Example 1; and

FIG. 7 presents a particle size distribution curve of the René 104 alloy powder without minor RE elements in Comparative Example 1.

### DETAILED DESCRIPTION OF THE EMBODIMENTS

The present disclosure will be further described below with reference to the accompanying drawings and specific examples.

### Example 1

The method provided in the present disclosure was applied to the René 104 nickel-based superalloy below. The RE element Sc was added in a mass fraction of 0.08%. The alloy includes in percentage by weight: 20.6Co-13Cr-3.4Al-3.9Ti-3.8Mo-2.1W-2.4Ta-0.9Nb-0.05Zr-0.03B-0.04C-0.08Sc-the balance of Ni. The steps of preparing nickel-based superalloy powder for 3D printing using the technical solutions provided in the present disclosure were as follows:

(1) vacuum melting: putting René 104 nickel-based superalloy raw materials with RE Sc element added in a mass fraction of 0.08% into the melting crucible of a powder atomization furnace, and then heating and melting the raw materials in a vacuum atmosphere of 0.05 Pa by using an intermediate frequency (IF) induction power supply;

(2) degassing: vacuum degassing for 15 min after the raw materials are melted and completely alloyed;

(3) refining: introducing high-purity argon into the furnace to 0.1 MPa, a purity of the argon being 99.99 wt %, and an oxygen content of the argon being 0.00006 wt %, and holding the metal melt at 1650° C. for 15 min;

(4) atomization: flowing the melt down a draft tube at a weight flow rate of 3.8 kg/min, atomizing the metal melt into fine droplets with 4 MPa high-pressure and high-purity argon, the droplets being cooled and solidified to form spherical powders, and collecting the powders using a tank; and

(5) sieving: sieving the powders by airflow classification and ultrasonic vibration under an inert gas atmosphere after the powders are fully cooled, to obtain spherical nickel-based superalloy powders with a particle size of 15-53 μm and 53-106 μm, and then vacuum packaging.

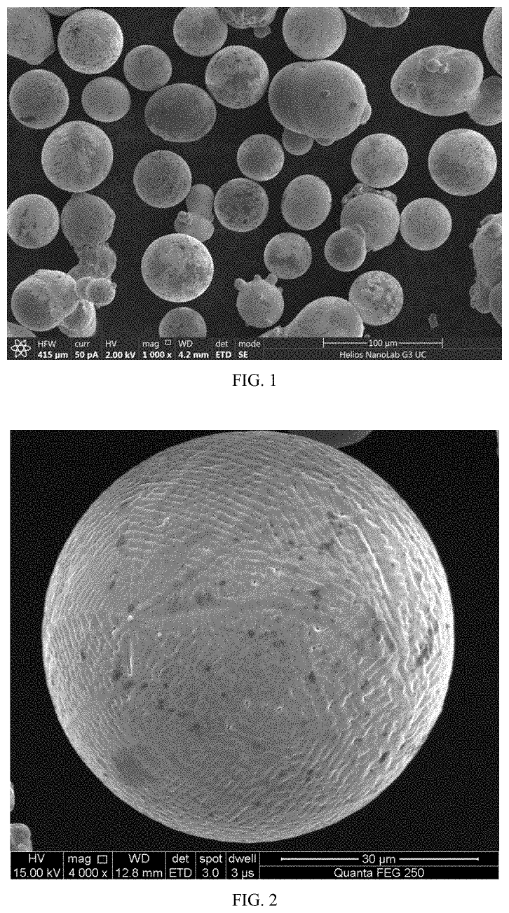

FIG. 1 presents an SEM image showing the René 104 nickel-based superalloy powder particles with 0.08% of RE elements that are prepared by gas atomization in Example 1 of the present disclosure. There are relatively few irregular powders or satellite powders, and the sphericity is high.

FIG. 2 presents a high-magnification SEM image showing the René 104 nickel-based superalloy powder particles with 0.08% of RE Sc elements that are prepared by gas atomization in Example 1 of the present disclosure. The sphericity is high, and the powder surface is smooth. The powders are mainly dendrites and a small number of cellular structures with fine grain sizes.

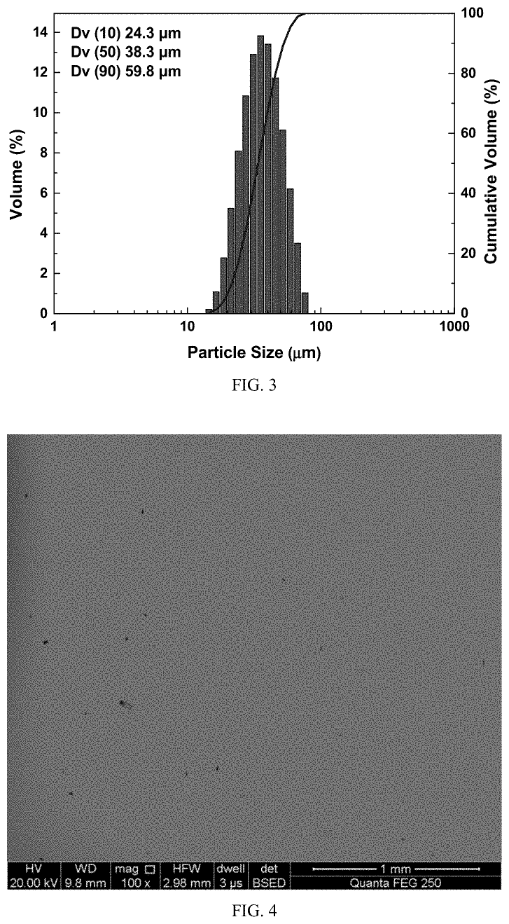

FIG. 3 presents a particle size distribution curve of René 104 nickel-based superalloy powders with 0.08% of RE elements that are prepared by gas atomization in Example 1 of the present disclosure. The particle size distribution is narrow, and the total yield of fine powders with a particle size of 15-53 μm and medium-sized powders with a particle size of 53-106 μm is up to 91.5%.

After analysis, the prepared René 104 nickel-based superalloy powder with 0.08% of RE elements has an oxygen content of 0.0093%, a sulfur content of 0.0021%, and a flowability of 15.8 s/50 g through a 2.5 mm aperture. The prepared powder has excellent performance, and can satisfy the requirements for 3D printing.

### Example 2

The method provided in the present disclosure was applied to the René 104 nickel-based superalloy below. The RE element Y was added in a mass fraction of 0.08%. The alloy includes in percentage by weight: 20.6Co-13Cr-3.4Al-3.9Ti-3.8Mo-2.1W-2.4Ta-0.9Nb-0.05Zr-0.03B-0.04C-0.08Y-the balance of Ni. The steps of preparing nickel-based superalloy powder for 3D printing using the technical solutions provided in the present disclosure were as follows:

(1) vacuum melting: putting René 104 nickel-based superalloy raw materials with RE element Y added in a mass fraction of 0.08% into the melting crucible of a powder atomization furnace, and heating and melting the raw materials in a vacuum atmosphere of 0.05 Pa by using an IF induction power supply;

(2) degassing: vacuum degassing for 15 min after the raw materials are melted and completely alloyed;

(3) refining: introducing high-purity argon into the furnace to 0.1 MPa, a purity of the argon being 99.99 wt %, and an oxygen content of the argon being 0.00006 wt %, and holding the metal melt at 1650° C. for 15 min;

(4) atomization: flowing the melt down a draft tube at a weight flow rate of 3.8 kg/min, atomizing the metal melt into fine droplets with 4 MPa high-pressure and high-purity argon, the droplets being cooled and solidified to form spherical powders, and collecting the powders using a tank; and

(5) sieving: sieving the powders by airflow classification and ultrasonic vibration under an inert gas atmosphere after the powders are fully cooled, to obtain spherical nickel-based superalloy powders with a particle size of 15-53 μm and 53-106 μm, and then vacuum packaging. The total yield of fine powders with a particle size of 15-53 μm and medium-sized powders with a particle size of 53-106 μm is 88.7%.

After analysis, the prepared René 104 nickel-based superalloy powder with 0.08% of RE Y element has an oxygen content of 0.0126%, a sulfur content of 0.0056%, and a flowability of 24.3 s/50 g through a 2.5 mm aperture.

### Example 3

The method provided in the present disclosure was applied to the René 104 nickel-based superalloy below. The RE elements Sc and Y were added in a mass fraction of 0.08%. The alloy includes in percentage by weight: 20.6Co-13Cr-3.4A1-3.9Ti-3.8Mo-2.1W-2.4Ta-0.9Nb-0.05Zr-0.03B-0.04C-0.04Sc-0.04Y-the balance of Ni. The steps of preparing nickel-based superalloy powder for 3D printing using the technical solutions provided in the present disclosure were as follows:

(1) vacuum melting: putting René 104 nickel-based superalloy raw materials with Sc element added in a mass fraction of 0.04% and Y element added in a mass fraction of 0.04% into the melting crucible of a powder atomization furnace, and heating and melting the raw materials in a vacuum atmosphere of 0.05 Pa by using an IF induction power supply;

(2) degassing: vacuum degassing for 15 min after the raw materials are melted and completely alloyed;

(3) refining: introducing high-purity argon into the furnace to 0.1 MPa, a purity of the argon being 99.99 wt %, and an oxygen content of the argon being 0.00006 wt %, and holding the metal melt at 1650° C. for 15 min;

(4) atomization: flowing the melt down a draft tube at a weight flow rate of 3.8 kg/min, atomizing the metal melt into fine droplets with 4 MPa high-pressure and high-purity argon, the droplets being cooled and solidified to form spherical powders, and collecting the powders using a tank; and

(5) sieving: sieving the powders by airflow classification and ultrasonic vibration under an inert gas atmosphere after the powders are fully cooled, to obtain spherical nickel-based superalloy powders with a particle size of 15-53 μm and 53-106 μm, and then vacuum packaging. The total yield of fine powders with a particle size of 15-53 μm and medium-sized powders with a particle size of 53-106 μm is 90.2%.

After analysis, the prepared René 104 nickel-based superalloy powder with 0.04% of RE Sc element and 0.04% of RE Y element has an oxygen content of 0.0114%, a sulfur content of 0.0048%, and a flowability of 21.2 s/50 g through a 2.5 mm aperture.

### Example 4

A René 104 alloy block was prepared with the alloy powder prepared in Example 1 as raw materials based on the 3D printing process parameters in Comparative Example 1 of Chinese Patent No. CN108941560B. Specific parameters of the SLM process are as follows:

the laser power is 225 W, the spot diameter is 0.12 mm, the scanning speed is 600 mm/s, the scanning space is 0.11 mm, and the powder layer thickness is 0.03 mm. (Partition strategy is not used.)

FIG. 4 is an SEM image showing the microstructure of the René 104 alloy prepared in Example 4. The as-built part has a dense structure, in which no cracks are observed.

After testing, the prepared René 104 alloy has a density of 99.2%, the yield strength of 913 MPa, tensile strength of 1247 MPa, and elongation of 13.3% at room temperature. Compared with the as-fabricated part after crack elimination by SPS in Example 1 of Chinese Patent No. CN108941560B, the yield strength and the tensile strength are increased by 21.6% and 38.4% respectively.

Using the alloy and its powder provided by the present disclosure, the as-built part with no cracks and excellent mechanical properties was prepared by the building process parameters corresponding to the most severe cracking and the worst performance in Chinese Patent No. CN108941560B. This indicates that the alloy and its powder provided by the present disclosure can broaden the 3D printing process window.

### Comparative Example 1

The method provided in the present disclosure was applied to the René 104 nickel-based superalloy below. The alloy includes in percentage by weight: 20.6Co-13Cr-3.4Al-3.9Ti-3.8Mo-2.1W-2.4Ta-0.9Nb-0.05Zr-0.03B-0.04C-the balance of Ni. The steps of preparing nickel-based superalloy powder for 3D printing using the technical solutions provided in the present disclosure were as follows:

(1) vacuum melting: putting René 104 nickel-based superalloy raw materials into the melting crucible of a powder atomization furnace, and heating and melting the raw materials in a vacuum atmosphere of 0.05 Pa by using an IF induction power supply;

(2) degassing: vacuum degassing for 15 min after the raw materials are melted and completely alloyed;

(3) refining: introducing high-purity argon into the furnace to 0.1 MPa, a purity of the argon being 99.99 wt %, and an oxygen content of the argon being 0.00006 wt %, and holding the metal melt at 1650° C. for 15 min;

(4) atomization: flowing the melt down a draft tube at a weight flow rate of 3.8 kg/min, atomizing the metal melt into fine droplets with 4 MPa high-pressure and high-purity argon, the droplets being cooled and solidified to form spherical powders, and collecting the powders using a tank; and

(5) sieving: sieving the powders by airflow classification and ultrasonic vibration under an inert gas atmosphere after the powders are fully cooled, to obtain spherical nickel-based superalloy powders with a particle size of 53-106 μm and 15-53 μm, and then vacuum packaging.

FIG. 5 presents an SEM image showing the René 104 nickel-based superalloy powder without minor RE elements that is prepared by gas atomization in Comparative Example 1 of the present disclosure. It can be observed that there are relatively many irregular powders or satellite powders.

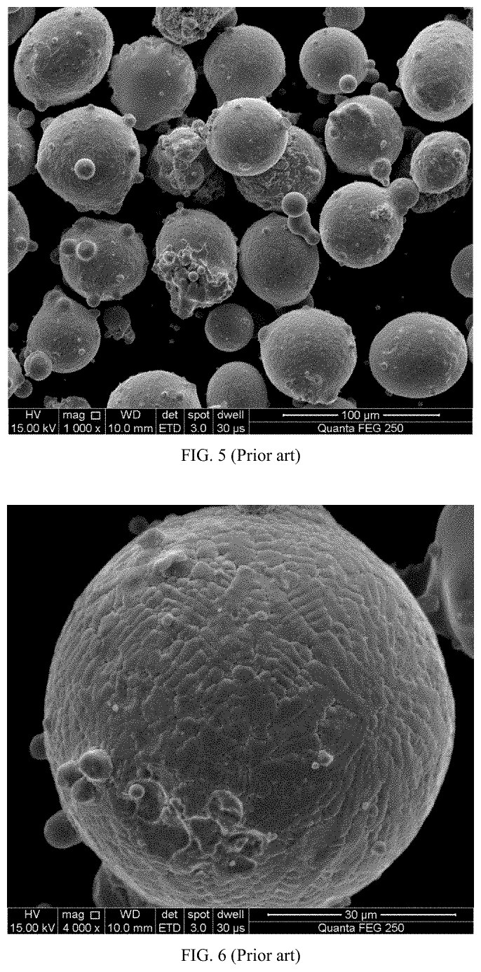

FIG. 6 presents a high-magnification SEM image showing the René 104 nickel-based superalloy powder without minor RE elements that is prepared by gas atomization in Comparative Example 1 of the present disclosure. There are satellite powders adhering to the powder surface.

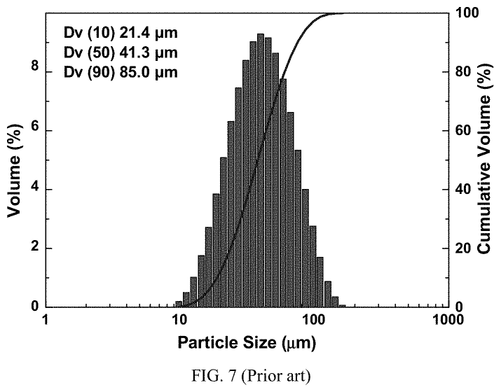

FIG. 7 presents a particle size distribution curve of René 104 nickel-based superalloy powder without minor RE elements that is prepared by gas atomization in Comparative Example 1 of the present disclosure. The particle size distribution is wider than that in Example 1, and the total yield of fine powders with a particle size of 15-53 μm and medium-sized powders with a particle size of 53-106 μm is only 74.1%.

After analysis, the prepared René 104 nickel-based superalloy powder has an oxygen content of 0.017%, a sulfur content of 0.0067%, and no flowability through a 2.5 mm aperture. The prepared powder has poor performance, and cannot satisfy the requirements for 3D printing.

### Comparative Example 2

The method provided in the present disclosure was applied to the René 104 nickel-based superalloy below. The alloy includes in percentage by weight: 20.6Co-13Cr-3.4Al-3.9Ti-3.8Mo-2.1W-2.4Ta-0.9Nb-0.05Zr-0.03B-0.04C-0.04Sc-the balance of Ni. The steps of preparing nickel-based superalloy powder for 3D printing using the technical solutions provided in the present disclosure were as follows:

(1) vacuum melting: putting René 104 nickel-based superalloy raw materials with RE element Sc added in a mass fraction of 0.04% into the melting crucible of a powder atomization furnace, and heating and melting the raw materials in a vacuum atmosphere of 0.05 Pa by using an IF induction power supply;

(2) degassing: vacuum degassing for 15 min after the raw materials are melted and completely alloyed;

(3) refining: introducing high-purity argon into the furnace to 0.1 MPa, a purity of the argon being 99.99 wt %, and an oxygen content of the argon being 0.00006 wt %, and holding the metal melt at 1650° C. for 15 min;

(4) atomization: flowing the melt down a draft tube at a weight flow rate of 3.8 kg/min, atomizing the metal melt into fine droplets with 4 MPa high-pressure and high-purity argon, the droplets being cooled and solidified to form spherical powders, and collecting the powders using a tank; and

(5) sieving: sieving the powders by airflow classification and ultrasonic vibration under an inert gas atmosphere after the powders are fully cooled, to obtain spherical nickel-based superalloy powders with a particle size of 15-53 μm and 53-106 μm, and then vacuum packaging. The total yield of fine powders with a particle size of 15-53 μm and medium-sized powders with a particle size of 53-106 μm is only 80.6%.

After analysis, the prepared René 104 nickel-based superalloy powder with 0.04% of RE Sc element has an oxygen content of 0.0144%, a sulfur content of 0.0073%, and a flowability of 40.5 s/50 g through a 2.5 mm aperture. When the added RE elements content is too low, the flowability of the powder is poor, which is not conducive to 3D printing.

### Comparative Example 3

The method provided in the present disclosure was applied to the René 104 nickel-based superalloy below. The alloy includes in percentage by weight: 20.6Co-13Cr-3.4Al-3.9Ti-3.8Mo-2.1W-2.4Ta-0.9Nb-0.05Zr-0.03B-0.04C-0.20Sc-the balance of Ni. The steps of preparing nickel-based superalloy powder for 3D printing using the technical solutions provided in the present disclosure were as follows:

(1) vacuum melting: putting René 104 nickel-based superalloy raw materials with RE element Sc added in a mass fraction of 0.20% into the melting crucible of a powder atomization furnace, and heating and melting the raw materials in a vacuum atmosphere of 0.05 Pa by using an IF induction power supply;

(2) degassing: vacuum degassing for 15 min after the raw materials are melted and completely alloyed;

(3) refining: introducing high-purity argon into the furnace to 0.1 MPa, a purity of the argon being 99.99 wt %, and an oxygen content of the argon being 0.00006 wt %, and holding the metal melt at 1650° C. for 15 min;

(4) atomization: flowing the melt down a draft tube at a weight flow rate of 3.8 kg/min, atomizing the metal melt into fine droplets with 4 MPa high-pressure and high-purity argon, the droplets being cooled and solidified to form spherical powders, and collecting the powders using a tank; and

(5) sieving: sieving the powders by airflow classification and ultrasonic vibration under an inert gas atmosphere after the powders are fully cooled, to obtain spherical nickel-based superalloy powders with a particle size of 15-53 μm and 53-106 μm, and then vacuum packaging. The total yield of fine powders with a particle size of 15-53 μm and medium-sized powders with a particle size of 53-106 μm is only 82%.

After analysis, the prepared René 104 nickel-based superalloy powder with 0.20% of RE Sc element has an oxygen content of 0.0087%, a sulfur content of 0.0018%, and a flowability of 17.4 s/50 g through a 2.5 mm aperture. In the process of melting and gas-atomizing, adding excessive RE elements would not further improve the powder performance, but increase the cost and the percentage of powders with a particle size of below 15 μm, and reduce the yield of powders that meet the required particle size for 3D printing.

What is claimed is:

1. A nickel-based superalloy for three-dimension (3D) printing, comprising the following components in percentage by mass:
Co: 14-23 wt %;
Cr: 11-15 wt %;
Al: 2-5 wt %;
Ti: 3-6 wt %;
Mo: 2.7-5 wt %;
W: 0.5-3 wt %;
Ta: 0.5-4 wt %;
Nb: 0.25-3 wt %;
Zr: 0.02-0.06 wt %;
B: 0.01-0.05 wt %;
C: 0.0015-0.1 wt %;
RE: 0.05-0.18 wt %; and
Ni: the balance;
or another non-weldable nickel-based superalloy is used as a matrix, and 0.05-0.18 wt % of RE is added to the matrix, wherein
the another non-weldable nickel-based superalloy is one selected from the group consisting of IN738LC, CM247LC, CMSX-4, René 142, and Hastelloy X; or one selected from the group consisting of nickel-based superalloys IN718 and IN625 is used as the matrix, and 0.05-0.18 wt % of RE is added to the matrix.

2. The nickel-based superalloy according to claim 1, comprising the following components in percentage by mass:
Co: 20.6 wt %;
Cr: 13 wt %;
Al: 3.4 wt %;
Ti: 3.9 wt %;
Mo: 3.8 wt %;
W: 2.1 wt %;
Ta: 2.4 wt %;
Nb: 0.9 wt %;
Zr: 0.05 wt %;
B: 0.03 wt %;
C: 0.04 wt %;
RE: 0.06-0.18 wt %; and
Ni: the balance.

3. The nickel-based superalloy according to claim 1, wherein RE is at least one selected from the group consisting of Sc, Y, La, Ce, and Er.

4. The nickel-based superalloy according to claim 3, wherein RE is Sc, or RE is a mixture of Sc and at least one selected from the group consisting of Y, La, Ce, and Er.

5. A method for preparing powder of the nickel-based superalloy according to claim 1, comprising the following steps:
step 1: vacuum melting:
formulating raw materials according to designed components, putting the raw materials into a melting crucible of a powder atomization furnace, then vacuum melting the raw materials by induction heating under a vacuum degree of higher than 0.1 Pa;
step 2: degassing:
after the raw materials are melted and completely alloyed to obtain a molten master alloy melt, vacuum degassing the molten master alloy melt for 10 min-20 min;
step 3: refining:
introducing high-purity inert gas into the powder atomization furnace to 0.1-0.11 MPa, and holding the molten master alloy melt at a temperature range of 1600° C.-1650° C. for 10 min-15 min;
step 4: atomization:
flowing the molten master alloy melt down a draft tube at a flow rate of 3.5 kg/min-5 kg/min, atomizing the molten master alloy melt into fine droplets with 3 MPa-5 MPa high-pressure and the high-purity inert gas, cooling and solidifying the fine droplets to form spherical powders, and collecting the spherical powders using a tank; and
step 5: sieving:
sieving the spherical powders by airflow classification and ultrasonic vibration under an inert gas atmosphere after the spherical powders are fully cooled, to obtain spherical nickel-based superalloy powders with a particle size of 53-106 μm and a particle size of 15-53 μm, and then vacuum packaging the spherical nickel-based superalloy powders to obtain the powder of the nickel-based superalloy;
wherein the high-purity inert gas is helium, argon, or a mixture gas of argon and helium, with a purity of 99.99 wt %, and an oxygen content less than 0.0001 wt %.

6. The method according to claim 5, wherein the raw materials contain Al-RE intermediate alloy.

7. The method according to claim 5, wherein a total yield of medium-sized powders with the particle size of 53-106 μm and fine powders with the particle size of 15-53 μm is 88.5%-91.5%.

8. The method according to claim 5, wherein the powder of the nickel-based superalloy for 3D printing has an oxygen content less than or equal to 0.0126 wt %, and a sulfur content less than or equal to 0.0056 wt %.

9. The method according to claim 8, wherein the powder of the nickel-based superalloy for 3D printing has an oxygen content less than or equal to 0.01 wt %, and a sulfur content less than or equal to 0.004 wt %.

10. The method according to claim 5, wherein the powder of the nickel-based superalloy for 3D printing has a flowability of 15-25 s/50 g, preferably 15.5-16 s/50 g, through an aperture of 2.5 mm.

11. The method according to claim 5, the nickel-based superalloy comprises the following components in percentage by mass:
Co: 20.6 wt %;
Cr: 13 wt %;
Al: 3.4 wt %;
Ti: 3.9 wt %;
Mo: 3.8 wt %;
W: 2.1 wt %;
Ta: 2.4 wt %;
Nb: 0.9 wt %;
Zr: 0.05 wt %;
B: 0.03 wt %;
C: 0.04 wt %;
RE: 0.06-0.18 wt %; and
Ni: the balance.

12. The method according to claim 5, wherein RE is at least one selected from the group consisting of Sc, Y, La, Ce, and Er.

13. The method according to claim 12, wherein RE is Sc, or RE is a mixture of Sc and at least one selected from the group consisting of Y, La, Ce, and Er.
